(19) United States
(12) Patent Application Publication
(10) Pub. No.: US 2025/0297971 A1
(43) Pub. Date: Sep. 25, 2025

(54) LIMITED ANGLE X-RAY SYSTEM

(71) Applicant: Lumafield, Inc., Cambridge, MA (US)

(72) Inventors: Adam P. Damiano, Somerville, MA (US); Scott Johnston, Boston, MA (US); Kevin David Cedrone, Boxborough, MA (US); Eduardo Jesus Torrealba, III, Cambridge, MA (US); Andreas Linas Bastian, San Francisco, CA (US); Andrew Parrett, Framingham, MA (US); Sahil Rajesh Shah, Cambridge, MA (US)

(21) Appl. No.: 19/084,514

(22) Filed: Mar. 19, 2025

Related U.S. Application Data
(60) Provisional application No. 63/567,219, filed on Mar. 19, 2024.

(51) Int. Cl. G01N 23/046

(52) U.S. Cl. CPC G01N 23/046; G01N 2223/1016; G01N 2223/3306; G01N 2223/3307; G01N 2223/423; G01N 2223/643

(57) ABSTRACT

X-ray systems, including apparatus, methods, and medium-encoded computer program products, to obtain computed tomography scan data (e.g., for limited angle computed tomography) include: a stationary X-ray source; and at least one detector configured to obtain limited angle computed tomography scan data of an object, the limited angle computed tomography scan data including projections of the X-rays after interaction with the object having been moved through an angular range with respect to at least one straight line between the stationary X-ray source and the at least one detector, and a conveyor system moves the object in a product handling line, a component of the conveyor system rotates the object around an axis that is normal or oblique to a travel direction of the conveyor system, and the scan data includes the projections of the X-rays after the interaction with the object having been rotated through the angular range around the axis.

### CROSS-REFERENCE TO RELATED APPLICATIONS

This application claims the benefit of U.S. Provisional Application Ser. No. 63/567,219 filed on Mar. 19, 2024, the entire contents of which are hereby incorporated by reference in its entirety.

### TECHNICAL FIELD

The application relates generally to limited angle X-ray system.

### BACKGROUND

X-ray systems can be used to detect defect(s) in and/or damage to an object without disassembling the object. X-ray systems are particularly useful to give manufacturers the ability to inspect certain parts of their products in a non-invasive, non-destructive fashion. Given this, X-ray devices are becoming more popular in production settings where quality control is of high importance.

Three-dimensional (3D) X-ray CT is a powerful inspection technology for both individual parts as well as assembled final products. The 3D scan data from a CT scan combines a series of X-ray projections taken from different projection angles and uses computer processing techniques to create a 3D reconstruction of the scan object. 3D X-ray CT can be used to make quality decisions about a part or to monitor upstream processes because 3D CT scan provides more detailed information than two-dimensional (2D) X-ray images. However, full CT scans typically require X-ray projections taken from a full 360 degrees rotation or a substantial fraction of a full rotation and typically take too long to be used in many production settings.

Two-dimensional (2D) X-ray scan data is used in part inspection in some industries, such as the electronics, food, and beverage industries, for quality verification, assembly verification, and foreign material detection. 2D X-ray scan data is faster to acquire than full CT scan data, but does not provide full 3D information about the relative location of components or the densities of overlapping materials in the inspected parts.

### SUMMARY

Some X-ray systems are limited angle CT systems, which capture a series of X-ray projections taken from a limited range of angles around the object rather than a full 3D scan around the object. Examples of limited angle CT systems include systems that perform tomosynthesis or laminography. The limited angle CT scan data can be captured faster than a full CT scan and is able to capture some 3D information about the scanned object through a partial 3D reconstruction.

However, some limited angle CT systems require linear or arc acquisition trajectories by moving the source, the detector, or both. Some limited angle CT systems implement circular trajectories by spinning the object to-be-scanned on an X-ray transmissive tray. In some of these circular trajectory systems, the source, the detector, or both are still required to be independently moved. Moving the source and/or the detector during the acquisition of X-ray projections requires maintaining a high degree of precision across the acquisition trajectories. The high precision requirement increases design and manufacturing costs. Components supporting the source and/or the detector have to be stiff, and motion components have to be both accurate and precise. For example, the systems implementing arc-based trajectories may require custom motion components, e.g., an arc-shaped motion track.

This specification describes technologies relating to a limited angle X-ray system that collect sufficient data for at least partial 3D reconstruction across a varied set of conditions relating to the geometry of the X-ray source, detector(s), and objects-to-be-scanned. In particular, the limited angle X-ray system includes architectural designs that facilitate acquisition of limited angle X-ray projections by moving an object to-be-scanned, rather than moving the X-ray source, the detector, or both.

Particular embodiments of the subject matter described in this specification can be implemented to realize one or more of the following advantages. In some implementations, the system can achieve high throughput scanning of an object translated between a stationary source and at least one detector via a conveyor system. For example, the system can achieve a scan rate of over ten objects per minute, or at a scanning speed about 1 meter per second. Instead of using an area detector which may be bottlenecked by data processing speeds, the system can include one or more linear detectors that can quickly acquire limited angle projections from multiple angles as the object translates between the source and detector(s) via the conveyor system. In some implementations, instead of moving the imaging components, i.e., one or both of the source and the detector(s), the system can acquire limited angle scan data by rotating the object using a component of a conveyor system. By moving the scanned object instead of part of or the entire imaging components, overall system complexity and cost can be reduced.

The details of one or more embodiments of the subject matter described in this specification are set forth in the accompanying drawings and the description below. Other features, aspects, and advantages of the invention will become apparent from the description, the drawings, and the claims.

### BRIEF DESCRIPTION OF THE DRAWINGS

FIG. 1 shows a cross-sectional and schematic view of an example limited angle X-ray system.

FIG. 2 shows a cross-sectional and schematic view of an example limited angle X-ray system with linear detector(s).

FIG. 3A shows a cross-sectional and schematic view of an example limited angle X-ray system.

FIGS. 3B-3C show example profiles for an example guide rail system for the part movement shown in FIG. 3A.

FIGS. 4A-4B show examples of a fixture that holds an object during a scan.

FIG. 5 shows a cross-sectional and schematic view of an example multi-energy X-ray system.

FIGS. 6A-6B show a cross-sectional and schematic view of an example X-ray system with localized shielding.

FIG. 7 shows a cross-sectional and schematic view of an example X-ray system with multi-modality acquisition.

FIG. 8 is a diagram showing an example of using artificial intelligence (AI) in manufacturing.

FIG. 9A shows a cross-sectional and schematic view of an example limited angle X-ray system that obtains multiple limited angle CT scans.

FIG. 9B shows a cross-sectional and schematic view of an example limited angle X-ray system that obtains multiple limited angle CT scans.

FIG. 10A shows an example conveyor system in a limited angle X-ray system.

FIG. 10B shows an example motion of a part moved by the example conveyor system in FIG. 10A.

FIG. 10C shows a second example motion of a part moved by the example conveyor system in FIG. 10A.

FIG. 10D shows a third example motion of a part moved by the example conveyor system in FIG. 10A.

FIG. 11 shows another example conveyor system 1100 in a limited angle X-ray system.

FIG. 12 shows example fiducials (or markers) used for motion tracking of a part imaged by a limited angle X-ray system.

Like reference numbers and designations in the various drawings indicate like elements.

### DETAILED DESCRIPTION

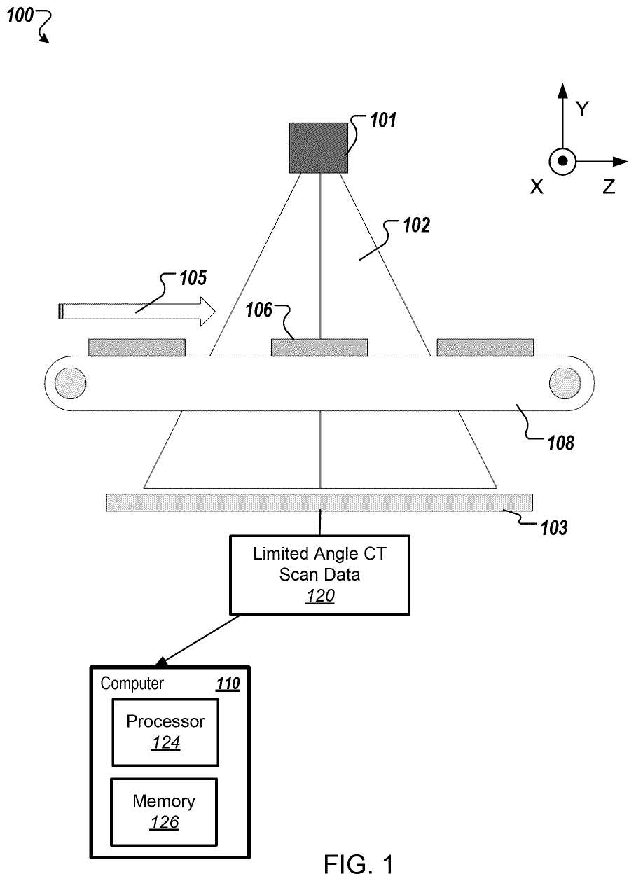

FIG. 1 shows a cross-sectional and schematic view of an example limited angle X-ray system 100. The system 100 includes a stationary X-ray source 101 configured to emit X-rays 102 towards at least one detector 103. The stationary X-ray source 101 is at a fixed location and does not move during use. The detector 103 obtains scan data of an object 106 that passes through the X-ray system 100.

The system 100 can acquire a set of projections from the detector 103. These projections encode both the energy and quantity of X-ray photons that the detector detects. The X-ray light, which is emitted from the X-ray source 101 can contain distinct energies that are subsequently attenuated by any matter (e.g., the object 106) between the X-ray source and the detector. The difference in X-ray intensity emitted by the X-ray source and captured by the detector provides information, e.g., densities, about the materials within the path of the X-ray photons.

The detector 103 can be configured to detect at least one X-ray signal. In some implementations, the detector 103 refers to a detector assembly that includes a scintillator and a camera. The scintillator is configured to absorb the X-rays that pass through the object 106 and emit light. The camera is configured to detect the light and generate an image using the detected light.

In some implementations, the detector 103 can include any suitable combination of a complementary metal-oxide-semiconductor (CMOS) digital camera sensor, a red-green-green-blue (RGGB) Bayer filter, an optical camera, a monochromatic optical camera, a back-side-illuminated sensor, a front-side-illuminated sensor, a charge-coupled device (CCD) detector, a photodiode, an X-ray flat panel detector, and a linear X-ray detector. The scan data acquired from the detector 103 can be referred to as a projection, which represents the raw scan data from the detector.

The detector 103 is configured to obtain limited angle CT scan data 120 of the object 106 as the object 106 passes through the X-ray system 100. In some implementations, the object 106 stops its motion during X-ray data acquisition. In some implementations, the object 106 continues to move during X-ray data acquisition. In some implementations, the system 100 can include a conveyor system 108 that moves the object 106 in a product handling line and through the X-ray system 100. Examples of the product handling line include a product manufacturing line, a product packaging line, a product receiving line, and other kinds of product handling lines.

For high throughput scanning, a common scanning configuration is to have a sequence of objects translated between an X-ray source and a detector via a conveyor system, e.g., a conveyor belt. This configuration improves throughput because the motion trajectory is simple, and the conveyor system can easily integrate into an existing production infrastructure. The conveyor system 108 can move the object 106 along a direction of travel 105, e.g., in the Z direction in the coordinate system defined in FIG. 1, where gravity is in the negative Y direction. For example, the conveyor system 108 can be a planar linear conveyance system for a sequence of objects being inspected in a product handling line. The traveling path of the objects can be any suitable path that moves the objects, such as a linear path, or a serpentine path.

The limited angle CT scan data 120 includes projections of the X-rays 102 after intersection with the object 106 that has been moved through a limited angular range. In some implementations, the system 100 can move the object through an angular range of between 5 and 180 degrees with respect to at least one straight line between the stationary X-ray source 101 and the detector 103. Instead of acquiring a full 360 degrees scan, the system 100 can quickly acquire the limited angle CT scan data 120 that includes sufficient 3D information for inspection of the object 106 or a region of interest in the object 106.

The limited angle CT scan data 120 can include two or more projections. In some implementations, the limited angle CT scan data 120 can include two projections that are to be processed by a computer vision algorithm or an artificial intelligence (AI) algorithm, e.g., a machine learning based 3D reconstruction algorithm, or a machine learning algorithm trained on images with ground truth labels and used to classify properties of the object based on the two or more projections. In some implementations, the limited angle CT scan data 120 can include thousands of projections, e.g., 2000 to 3000 projections, which are to be processed to generate a high-resolution partial 3D reconstruction. For example, high resolution partial 3D reconstructions generated from limited angle CT scans can achieve pixel/voxel sizes below 10 microns.

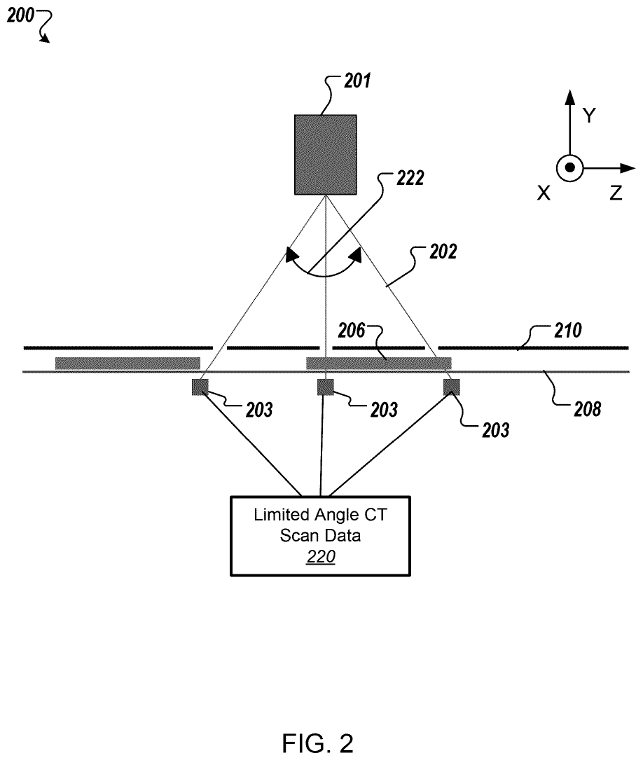

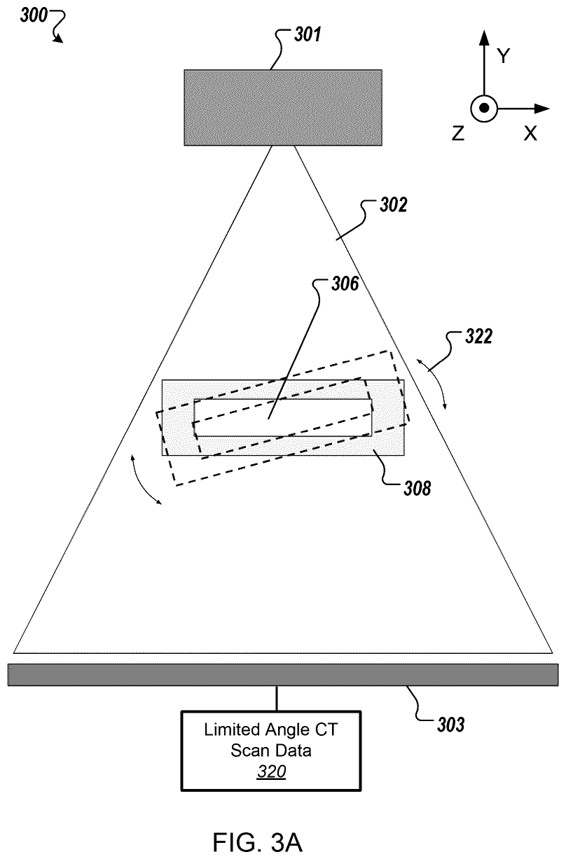

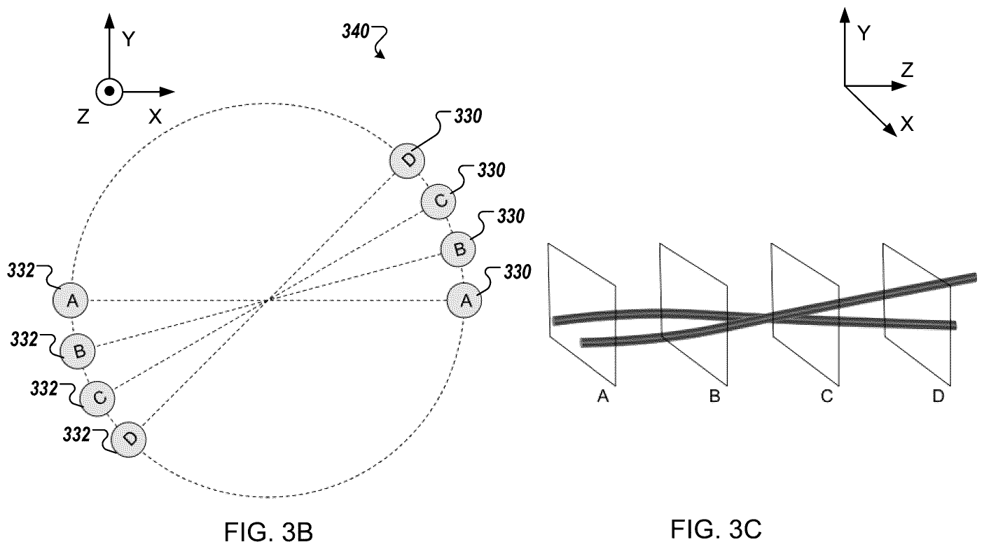

In some implementations, the system 100 can include one or more linear detectors 103 that can perform fast acquisition of projections with a limited angular range as the object 106 translates between the source 101 and detector 103 via the conveyor system 108. In some implementations, the system 100 can acquire limited angle scan data 120 by rotating the object using a component of the conveyor system. More details of these various implementations are described below in connection with FIG. 2 and FIGS. 3A-3C.

A computer 110 obtains and processes the limited angle CT scan data 120. The computer 110 can generate a partial 3D reconstruction of the object 106 using the limited angle CT scan data 120, e.g., using a limited angle CT reconstruction algorithm. Unlike 2D X-ray radiography generated from 2D projections, the partial 3D reconstruction, which is a computer data structure that provides data representing the object 106 in 3D space, can provide dimensionally accurate spatial and material information about both the inside and outside of the object 106, or a part or component thereof. Using the partial 3D reconstruction, the system 100 can perform inspections of a scan object that is not available using 2D projections.

Before being input to the limited angle CT reconstruction algorithm, the projections can be further processed in a number of ways, which are sometimes referred to as post-processing of the projections. In some implementations, the projections can be summed (i.e., combined) and/or averaged before being reconstructed to produce a partial 3D reconstruction. In some implementations, the projections can be individually or collectively processed to improve resulting reconstruction data quality and to reduce artifacts of the X-ray CT process, such as beam hardening, ring artifacts, or other common artifacts. In some implementations, processing of the projections can also produce calibration information to improve reconstruction data quality.

The computer 110 can be one or more computers that are integrated with the X-ray system 100, and/or located remotely from the X-ray system 100 (e.g., at a remote server and communicatively coupled with the X-ray system 100, e.g., over the Internet). The computer 110 can include at least one processor 124. Processor(s) 124 can be embodied by any computational or data processing device, such as a central processing unit (CPU), application specific integrated circuit (ASIC), or comparable device. The processor(s) 124 can be implemented as a single controller, or a plurality of controllers or processors.

The computer can include at least one memory 126. The memory 126 can be fixed or removable. The memory 126 can encode computer program instructions or computer code contained therein. Memory 126 can be any suitable storage device, such as a non-transitory computer-readable medium. The term “non-transitory,” as used herein, can correspond to a limitation of the medium itself (i.e., tangible, not a signal) as opposed to a limitation on data storage persistency (e.g., random access memory (RAM) vs. read-only memory (ROM)). A hard disk drive (HDD), random access memory (RAM), flash memory, or other suitable memory can be used. The one or more memories can be combined on a same integrated circuit as one or more processors, or can be separate from the one or more processors. Furthermore, the computer program instructions stored in the memory, and which can be run by the processor(s), can be any suitable form of computer program code, for example, a compiled or interpreted computer program written in any suitable programming language. In some implementations, the computer 110 can store the limited angle CT scan data 120, the partial 3D reconstruction derived from the limited angle CT scan data 120, or a combination of both, in the memory 126.

The processor 124, the memory 126, and any subset thereof, can be configured to perform one or more processes including CT scanning and data acquisition, post-processing, partial 3D reconstruction, and generating a response to a prompt input related to the scan object using an artificial intelligence (AI) model. The memory and the computer program instructions can be configured, with the processor for the particular device, to cause a hardware apparatus to perform one or more of the processes described in this application. Therefore, in some implementations, a non-transitory computer-readable medium is encoded with computer instructions that, when executed in hardware, perform a process such as one of the processes described herein. In some cases, one or more of the processes described herein are implemented entirely in hardware.

As noted above, in some implementations, these processes can be performed by the X-ray system 100, and so no separate computer is needed. In such implementations, the computer 110 and the X-ray system 100 are integrated into a single device, rather than being in separate devices as shown in FIG. 1. In some implementations, the X-ray system 100 is an inexpensive scanning device with minimal processing capabilities, and a separate computer 110 is communicatively coupled with the X-ray system 100 and is configured to perform one or more of the processes described herein.

The X-ray system 100 in FIG. 1 is a top-down system that includes a detector 103 that is below the conveyor system 108 and an X-ray source 101 that is above the object 106. The described techniques in this specification are applicable to other possible architectures and/or arrangements not shown in FIG. 1. For example, a possible limited angle X-ray system can be a bottom-up system that includes an X-ray source that is below the conveyor system and a detector that is above the object.

FIG. 2 shows a cross-sectional and schematic view of an example limited angle X-ray system 200 with linear detector(s). A linear detector includes a single row of X-ray detectors that can be configured to generate one-dimensional (1D) projection during an X-ray scan. The system 200 includes at least one linear detector 203 along a conveyor system 208. The at least one linear detector 203 can be configured to obtain two or more projections that are included in the limited angle CT scan data 220.

A linear detector has the advantages of being fast and less expensive than an area detector. A linear detector can be easily integrated into conveyor systems. An area detector, on the other hand, provides a range of viewing angles of the object, thus allowing for discerning features that may be indistinguishable from one angle because the features are stacked. Unfortunately, an area detector may be bottlenecked by data processing speeds, e.g., generating scan data at a rate that can be hundreds to thousands of times slower than a linear detector, making it difficult to provide real time processing of the scan data and to be integrated into high throughput systems and applications. For example, linear detectors can have frame rates in the thousands of frames per second, while most area detectors (e.g., flat panel detectors) can achieve a maximum frame rate that is less than 100 frames per second. In some implementations, the limited frame rate of area detectors can make it difficult to achieve desired high conveyance speed in order to avoid and/or reduce motion blur.

In some implementations, the at least one linear detector 203 includes two or more stationary linear detectors along the conveyor system 208. Both the X-ray source 201 and the two or more stationary linear detectors are stationary in the system 200 and do not move. As an object 206 moves along a direction of travel (e.g., the Z direction) of the conveyor system 208, the system 208 can obtain two or more projections at the two or more stationary linear detectors. The object continues to move during X-ray data acquisition. Thus, the system can obtain limited angle CT scan data through an angular range 222 determined by the locations of the two or more linear detectors 203. In some implementations, the angular range 222 can be between 5 and 125 degrees. By having two or more linear detectors along the conveyor system 208, an object 206 can be seen from more than one angle, allowing for the discrimination of different features in the object 206 in 3D.

For example, as shown in FIG. 2, the system 200 can include three linear detectors 203, e.g., one underneath the X-ray source, one towards the left, and one towards the right. The X-ray source 201 emits X-rays 202 towards the three linear detectors. Two objects are being translated via a conveyor system 208 horizontally to the right. When one object 206 travels to a location that is above one of the detectors, the system 200 can capture a corresponding projection of the object 206. Thus, the system can obtain limited angle CT scan data of the object 206 through discretely sampling an angular range 222 defined by the locations of the three linear detectors 203.

In some implementations, at least one detector 203 can include a single linear detector that is located along that conveyor system 208 and moves based on the travel direction of the conveyor system. The single linear detector 203 can obtain projections of the object 206 while the single linear detector 203 moves based on a travel direction of the conveyor system 208. In some implementations, the object stops its motion during X-ray data acquisition. In some implementations, the object continues to move during X-ray data acquisition. Thus, using a single moving linear detector 203, the system 200 can obtain projections of the object 206 from the same vantage points as the two or more linear detectors in the previously described implementation. For example, FIG. 2 can be viewed as showing a single linear detector 203 that moves to three different locations. Thus, the system can obtain limited angle CT scan data through discretely sampling an angular range 222 determined by the locations of the single linear detector 203. In some implementations, the angular range 222 can be between 5 and 125 degrees. The linear detector 203 can move on a set of rails to different locations, e.g., moves from left to right following the direction of travel of the conveyor system 208. In some implementations, the system 200 can include a combination of one or more stationary linear detectors and one or more non-stationary linear detectors that move based on the travel direction of the conveyor system.

In some implementations, the object 206 or a component of the object 206 can be sensitive to X-ray dose, the system 200 can include a shielding 210 between the X-ray source 201 and the object 206, to prevent unnecessary radiation exposure to the object 206. The shielding 210 can be produced using highly X-ray attenuating and chemically inert material, such as lead, tungsten, bismuth, or tantalum. In some implementations, the shielding 210 can prevent or reduce scatter in the system 200. In some implementations, stationary shielding 210 can be added along the conveyor system 208 and partially covers the dose sensitive object 206. For example, the shielding 210 can include multiple slits corresponding to the one or more linear detectors 203 and/or its locations.

FIG. 3A shows a cross-sectional and schematic view of an example limited angle X-ray system 300. The system 300 includes a stationary X-ray source 301 and at least one stationary detector 303. The at least one stationary detector 303 can include multiple detectors, e.g., one or more linear detectors, or one detector, e.g., an area detector or a single linear detector. For example, multiple detectors can be placed within the X-ray beam or cone of a stationary X-ray source. A conveyor system (not shown) moves an object 306 in a product handling line along a travel direction of the conveyor system. For example, FIG. 3A shows a side view of the system 300 (e.g., a front view of the system that is similar to the system 100 shown in FIG. 1) and a conveyor system moves the object 306 in the Z direction.

A component of the conveyor system can rotate the object 306 around an axis that is based on a travel direction of the conveyor system. In some implementations, the component of the conveyor system can be a guide rail system of a conveyor. For example, the guide rail system can change an orientation or a slope of a conveyor belt of the conveyor system. In some implementations, the guide rail system can include motion actuators that alter the orientation (e.g., inclination) of the plane of conveyance. More details of a guide rail system for the object movement are described below in connection with FIGS. 3B-3C.

In some implementations, the component of the conveyor system can be a conveyed fixturing system that holds the object on a conveyor. For example, as shown in FIG. 3A, the conveyed fixturing system can include a fixture 308, e.g., a tray. The fixture 308 can be installed and fixed on a conveyor and holds the object 306. The fixture 308 is made of an X-ray transmissible material, allowing the object to be imaged by the X-ray system 300. For example, the fixture 308 can be an X-ray transmissive tray and the X-rays 302 are not significantly attenuated by the X-ray transmissive material in the fixture 308. The fixture 308 rotates the object 306 around an axis that is based on a travel direction of the conveyor system (e.g., the Z direction).

In some cases, the component of the conveyor system (e.g., the conveyed fixturing system in FIG. 3A or a guide rail system in FIGS. 3B-3C) can rotate the object 306 around an axis that is parallel to the travel direction of the conveyor system and in plane with the conveyance surface. In some cases, the component of the conveyor system can rotate the object 306 around an axis that is normal to the travel direction of the conveyor system and in plane with the conveyance surface. In some implementations, the component of the conveyor system can rotate the object 306 in a sequence of steps, e.g., first around the axis that is parallel to the travel direction of the conveyor system, and then around the axis that is normal to the travel direction of the conveyor system.

The system 300 obtains limited angle CT scan data 320 while the object 306 is rotated. In some implementations, the object stops its motion during X-ray data acquisition. In some implementations, the object continues to move during X-ray data acquisition. The limited angle CT scan data 320 includes projections of the X-rays 302 after the X-rays 302 interact with the object 306 having been rotated through a limited angular range 322. In some implementations, the limited angular range 322 can be an angular range between 5 and 180 degrees around the axis. In some implementations, the limited angular range 322 can be below a maximum angle, e.g., below 70, 90, 120, 125, 150, or 170 degrees, and above a minimum angle suitable for a partial 3D reconstruction, e.g., above 3, 10, or 15 degrees. In some implementations, a conveyed fixturing system, e.g., a fixture 308, can ensure that the object 306 does not move inside the fixture 308 during acquisition of the projections.

The system 300 obtains the limited angle CT scan data 320 by only moving a scan object 306, e.g., through a limited angular range 322. Instead of moving part of or the entire imaging system (e.g., the source 301 and/or the detector 303), the system 300 obtains a viable limited angle CT scan trajectory that is traditionally accomplished by moving the source and/or detector, thus reducing the overall system complexity and reducing the cost of the overall system.

FIGS. 3B-3C show example profiles for an example guide rail system 340 for the object movement shown in FIG. 3A. The guide rail system 340 can enforce both translation and rotation of the object 306, resulting in a partial helical motion path of the object. FIG. 3B shows a rail profile for angular rotations as a function of distance along the direction of travel of the conveyor system. FIG. 3B is viewed from a plane (e.g., X-Y plane) that is perpendicular to the direction of travel of the conveyor system (e.g., the Z direction). The rail profile includes locations of two edges 330 and 332 of the rail. As the conveyor system translates to four locations A, B, C, D, the two edges of the rail rotate the object to a sequence of angles, e.g., 0 degrees at A, 15 degrees at B, 30 degrees at C, and 45 degrees at D, resulting in the rotation of the object 306 at an angular range between 0 to 45 degrees. FIG. 3C shows a profile of the rail system along the direction of travel of the conveyor system. The direction of travel of the conveyor system is in the Z direction. When the conveyor system translates to four locations A, B, C, D, the two edges of the rail rotate to a sequence of angles, resulting in a partial helical motion path.

In some implementations, any of the systems 100, 200, and 300 can include fiducials for at least one of material identification, physical alignment, and/or calibration. Material identification fiducials can include one or more examples of known materials or one or more stacks of known materials in known locations that can be used to help identify unknown foreign contaminants. Physical alignment fiducials can include physical features that repeatedly mate together with accuracy and precision. Examples of physical alignment fiducials include kinematic couplings, locating pins, and bushings. Calibration fiducials can include fiducials that are used to ascertain the object's location and orientation, and ensure projection alignment. An example of calibration fiducials can be three or more ceramic spheres positioned about the perimeter of the fixture so that they are imaged, but do not interfere with the imaging of the object being scanned.

In some implementations, any of the system 100, 200, and 300 can include restraint features to ensure that the object does not move while being translated and/or rotated. These restraint features can be incorporated into a conveyed fixturing system, a guide rail system, the conveyor system, or a component included in the system. For example, the restraint features can be incorporated either into the X-ray system or into the sleds and/or pucks entering and exiting the X-ray system. In some implementations, the sleds and/or pucks entering and exiting the X-ray system can include fiducials for at least one of material identification, physical alignment, and/or calibration.

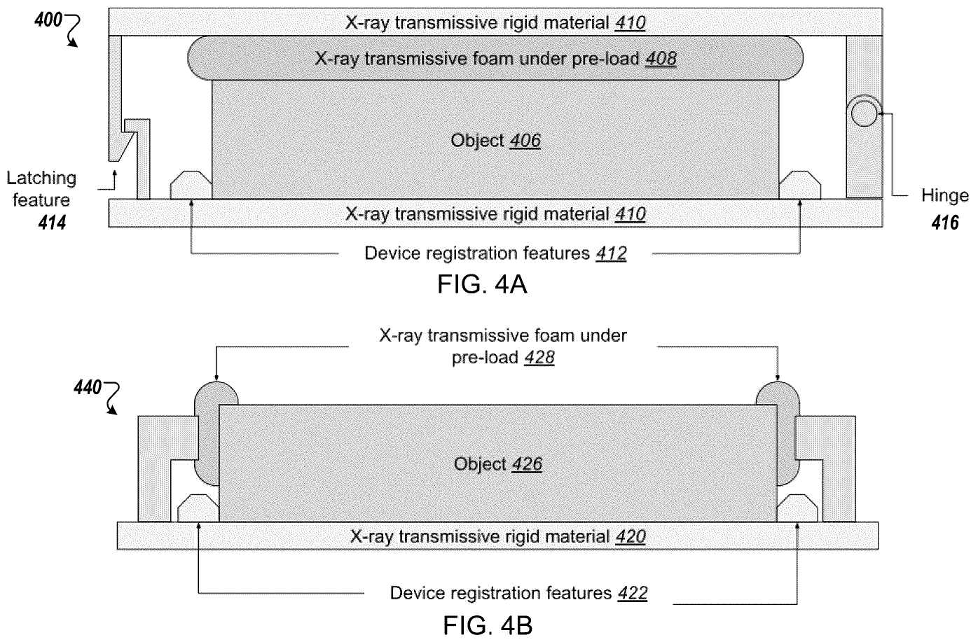

FIG. 4A shows an example of a conveyed fixturing system, e.g., a fixture 400, that holds an object 406 during a scan. The fixture 400 includes one or more restraint mechanisms, to restrain the object during a scan. The fixture 400 includes an X-ray transmissive rigid material 410 and/or structure, such as carbon fiber, a polymer honeycomb structure, or a rigid polyurethane foam at the top and bottom. The X-ray transmissive rigid material 410 ensures the rigid physical shape of the fixture 400. The fixture 400 includes an X-ray transmissive foam 408 or inflated airbag under preload. By having the X-ray transmissive foam 408 on top of the object 406 and the X-ray transmissive rigid material 410 under the object 406, the fixture 400 ensures that the object 406 is restrained vertically during an X-ray scan. The fixture 400 includes device registration features 412. In some implementations, the device registration features 412 can ensure that the object is restrained horizontally. In some implementations, the device registration features 412 can be detected in projections and/or a partial 3D reconstruction generated from the projections and can function as fiducials. For example, the projections and/or the partial 3D reconstruction can be processed, e.g., by the computer 110, to determine whether the object 406 is at the desired fixed location within the fixture 400. The fixture 400 includes a latching feature 414 and a hinge 416, such that the fixture can be opened and closed for the installation and removal of the object 406.

FIG. 4B shows another example of a conveyed fixturing system, e.g., a fixture 440, that holds an object 426 during a scan. The fixture 440 includes an X-ray transmissive rigid material 420 under the object 426. The fixture 440 includes X-ray transmissive foam 428 under preload at two sides of the object 426. By having the X-ray transmissive foam 428 at the two sides of the object 426 and the X-ray transmissive rigid material 420 under the object 426, the fixture 440 ensures that the object 426 is restrained both horizontally and vertically. The fixture 440 can include device registration features 422 that function similarly as the device registration features 412 described above. In some implementations, a fixture of any of the described X-ray systems in the application can include a combination of one or more restraint mechanisms shown in FIG. 4A and FIG. 4B.

Multi-energy (e.g., dual energy) X-ray imaging systems obtain scan data at multiple X-ray spectra by using X-rays at multiple energies. Multi-energy X-ray imaging systems can use different spectral responses of different materials to identify materials of a scan object. Some X-ray systems can generate X-rays with multiple X-ray spectra (e.g., low energy and high energy spectra) by using multiple X-ray sources, by taking different scans at different source energies, or by using a detector in which one or more rows of pixels have filtering. However, having multiple sources, a source that generates different energies, or a specialized filter in a detector can be expensive.

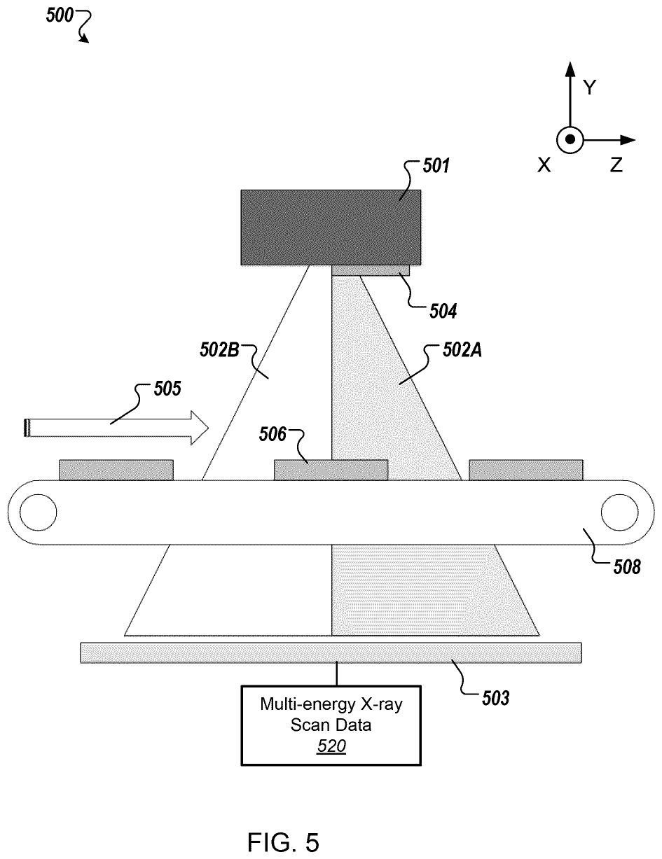

FIG. 5 shows a cross-sectional and schematic view of an example multi-energy X-ray system 500. One or more filters 504 can be used to create one or more regions of projected X-rays that have different average energies. This is less expensive than multiple sources with multiple X-ray energies or per-pixel filtering in detectors because the filter 504 can be a piece of metal (e.g., copper, aluminum, or tin) that has been manufactured to have two or more thicknesses. For example, the multi-energy X-ray system 500 includes a filter 504 placed between the X-ray source 501 and the object 506 and detector 503, which can obtain scan data for multi-energy X-ray scan. A portion of the X-rays 502A that passes through the filter 504 has a different energy spectrum than the X-rays 502B emitted from the X-ray source 501. The X-ray scan data 520 includes projections of the two portions of the X-rays at two different energy spectra (e.g., low and high energy) after the interaction with the object 506. The object 506 can be in a product handling line and can be translated by a conveyor system 508 with a direction of travel 505. Compared to using multiple sources, by using source-side X-ray beam filtering, the system 500 can achieve multiple spectra at a reduced cost. In some implementations, the filtered beam can be at a reduced flux, and the system 500 can use a high bit depth (e.g., 16, 24, or 32 bit depth) detector which can renormalize the projections that have lower brightness.

In some implementations, any of the limited angle X-ray systems 100, 200, or 300 can include one or more filters as described in connection with the multi-energy X-ray system 500, and can obtain limited angle multi-energy CT scan data that can be processed to identify materials of a scan object.

In some applications, e.g., consumer electronics, the object being inspected may contain sensitive (electronic) components, such as micro-electromechanical (MEM) devices or flash memory chips, which cannot be subject to more than a known total ionizing dose (TID). In these applications, an X-ray system can use localized shielding to shield sensitive components from excessive X-ray exposure. Localized shielding can be produced using highly X-ray attenuating material, such as lead, tungsten, bismuth, or tantalum. Rather than limiting the inspectability of the entire object, the localized shielding can remove this inspection limitation by reducing the TID to the sensitive component, enabling higher dose (e.g., higher flux or multiple X-ray images) inspection operations that were not previously possible, or a combination of both. In some implementations, an X-ray system can include localized shielding into fixturing or other ancillary devices to shield sensitive components while enabling inspection of other features in the object. For example, the limited angle X-ray system 300 can include localized shielding into the fixture 308 that holds the scan object 306.

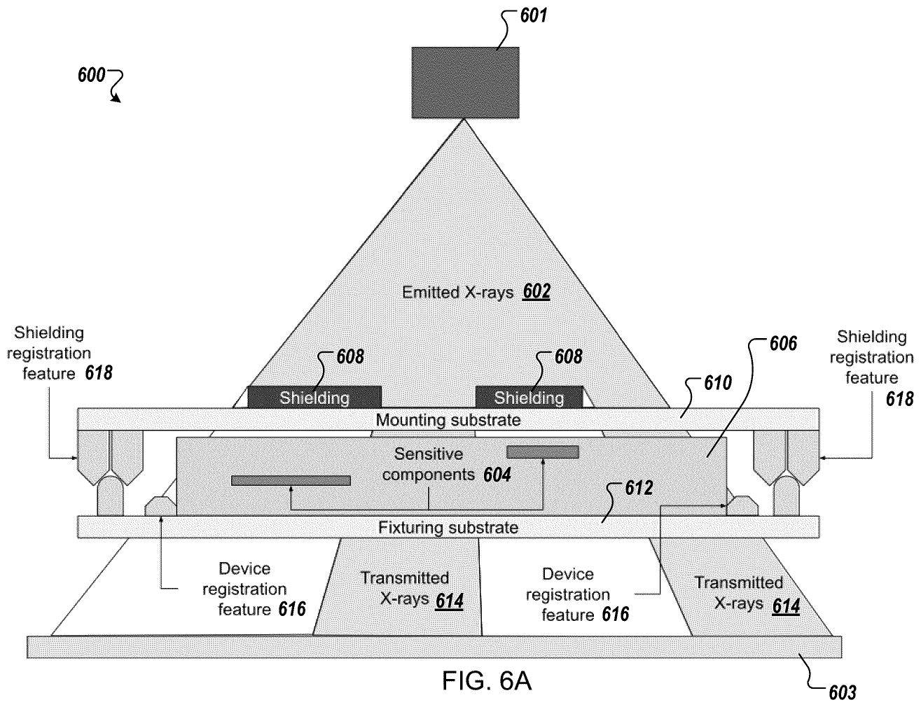

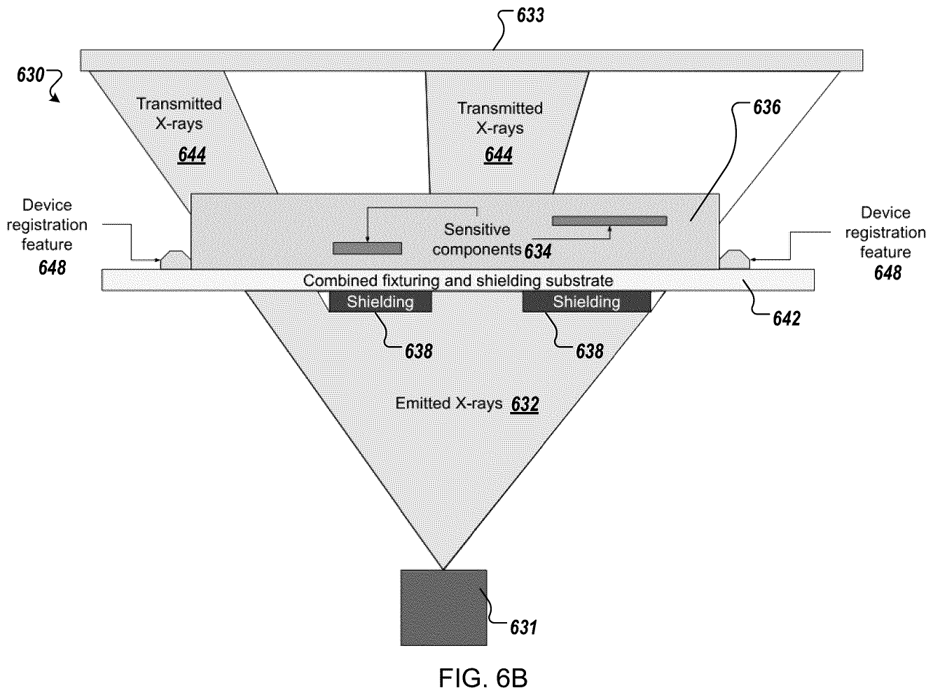

FIGS. 6A-6B show a cross-sectional and schematic view of an example X-ray system with localized shielding. The localized shielding can be mounted to an X-ray transmissive material of a fixture. The fixture can include physical alignment features, e.g., pegs, slots, kinematic coupling, to properly align the localized shielding relative to the object. FIG. 6A shows an example X-ray system 600 with localized shielding to reduce dose in specific areas in an object. The object 606 includes two sensitive components 604. A fixturing substrate 612 holds the object 606 and ensures the object 606 does not move relative to the fixturing substrate 612 during an X-ray scan, e.g., using device registration features 616. The system 600 includes a mounting substrate 610 that mounts two shieldings 608. The mounting substrate 610 includes shielding registration feature 618 ensuring that the shieldings 608 are registered at precise locations to block the X-rays 602 generated by the source 601 that would otherwise reach the sensitive components 604. By using the shieldings 608 correctly mounted and registered, the projections obtained at a detector 603 only include transmitted X-rays 614 not blocked by the shielding, thus protecting the sensitive components 604 in the object 606.

FIG. 6B shows an example X-ray system 630 with localized shielding that is incorporated into a device fixturing. The system 630 includes an X-ray source 631 that emits X-rays 632 from underneath the object 636 and includes a detector 633 that is above the object 636. The system 630 includes a combined fixturing and shielding substrate 642. The combined fixturing and shielding substrate 642 includes device registration features 648 that ensure the object 636 does not move relative to the fixturing substrate 642 during an X-ray scan. The combined fixturing and shielding substrate 642 includes two shieldings 638. The device registration features 648 ensure that the shieldings 638 are registered at precise locations to block the X-rays 632 that would otherwise reach the sensitive components 634 of the object 636. By using the shieldings 638 correctly mounted and registered, the projections obtained at the detector 633 only include transmitted X-rays 644 not blocked by the shielding, thus protecting the sensitive components 634 in the object 636.

In some implementations, the localized shielding can be product specific. In some implementations, the system can use modularity to reduce cost for producing the localized shielding for a particular object. In some implementations, the system can produce a localized shielding using 3D printing with a highly attenuating material, e.g., a tungsten or lead loaded polymer material. In some implementations, the localized shielding can include two pieces of shielding that sandwich the object. In some implementations, the localized shielding can include one or more holes to allow X-rays passing through the one or more holes for inspection of one or more portions of the object.

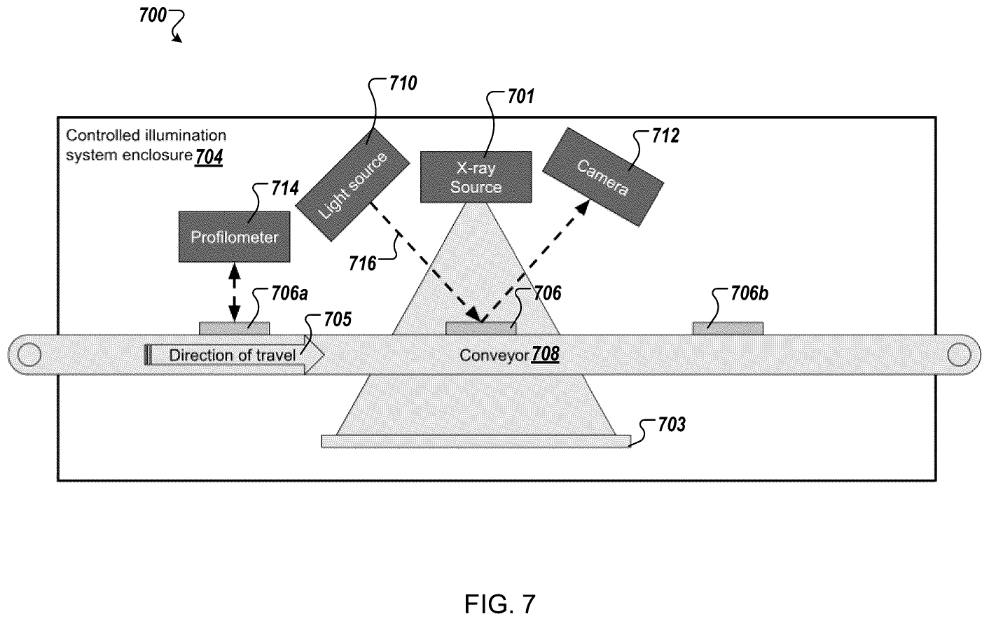

FIG. 7 shows a cross-sectional and schematic view of an example X-ray system 700 with multi-modality acquisition. The multi-modality acquisition described in connection with FIG. 7 can also be used in any of the systems 100, 200, 300, 500, 600, and 630. The X-ray system 700 includes components, e.g., X-ray source 701 and detector 703, that are configured to obtain an X-ray scan of an object 706. The object 706 can be in a product handling line and can be translated by a conveyor system 708 with a direction of travel 705. The X-ray system 700 includes an enclosure 704 surrounding the X-ray source 701 and the detector 703. In some implementations, the X-ray system 700 includes an optical inspection device in the enclosure 704. The optical inspection device can be configured to generate optical inspection data of the object 706.

The enclosure 704 can be a completely enclosed light-tight box. Thus, the enclosure 704 provides a controlled environment for performing other imaging tasks, e.g., using an optical inspection device. Examples of other imaging tasks include deflectometry, colorimetry, optical comparison, telecentric imaging, hyperspectral imaging, ultraviolet (UV) imaging, near-infrared (NIR) imaging, polarization imaging, profilometry, and fluorescence imaging. In agricultural inspection applications, colorimetry, hyperspectral imaging, NIR images, or a combination of these can be used in conjunction with an X-ray system. In consumer electronics inspection applications, deflectometry, polarization imaging, or a combination of both can be used in conjunction with an X-ray system.

For example, the optical inspection device can include a light source 710 that emits visible light 716, and a camera 712 that captures an image of the object 706 illuminated by the visible light 716. Light in wavelengths outside of the human visible spectrum can also be used. As another example, the optical inspection device can include a profilometer 714 that is configured to measure a profile and surface finish of a surface of an object 706a before it enters the X-ray scanning region.

Multi-modality imaging can save floor space in a production environment by having multiple imaging devices in the same enclosure in a single piece of equipment. Multi-modality imaging can perform measurements, e.g., scans and/or imaging of an object, in series, in parallel, or both, while the object is translated in a product handling line by a conveyor system, reducing cycle time and/or total number of cycles for object inspection.

In some implementations, different imaging modalities can be arranged in series along a conveyor system. For example, a profilometer can obtain a measurement for an object 706a, while the X-ray device obtains an X-ray scan of a different object 706 that is in front of the object 706a. In some implementations, measurements for two or more imaging modalities can be obtained in parallel. For example, the camera 712 can obtain an image of the object 706, at the same time when the X-ray device obtains an X-ray scan of the same object 706. In some implementations, deflectometry and X-ray imaging can be performed in parallel. In some implementations, if X-ray imaging and non-X-ray imaging modalities are performed in parallel, the system 700 can include additional shielding around non-X-ray imaging components to protect the non-X-ray imaging components.

In some implementations, data from one modality can be used in conjunction with data from another modality to reduce ambiguity or to make new measurements. In some implementations, the system 700 can be configured to combine the optical inspection data with the X-ray scan data and process the combined data to generate an inspection result of the object 706. In some implementations, combining multiple imaging modalities can improve detectability of defects.

For example, the combined data from multiple imaging modalities can improve detectability of scratches and dents on highly reflective surfaces, residual thin films, surface residues and blemishes, written text and codes on a surface of products (e.g., serial numbers, dot matrix codes engraved on castings) that can be difficult to image with visible light.

As another example, a structured light scanner can be used to generate a surface mesh of an exterior of an object. This surface mesh can be used to calibrate the surface extraction method from a 3D reconstruction that is generated from X-ray scan data obtained by an X-ray scanner, achieving a more accurate dimensional measurement of internal features of the object.

As another example, a visible light line scanner can be used to capture the color information of an object being scanned by an X-ray scanner, and can be used to produce accurately colored surface meshes, to read product identifiers, to provide cosmetic inspection, or a combination of these.

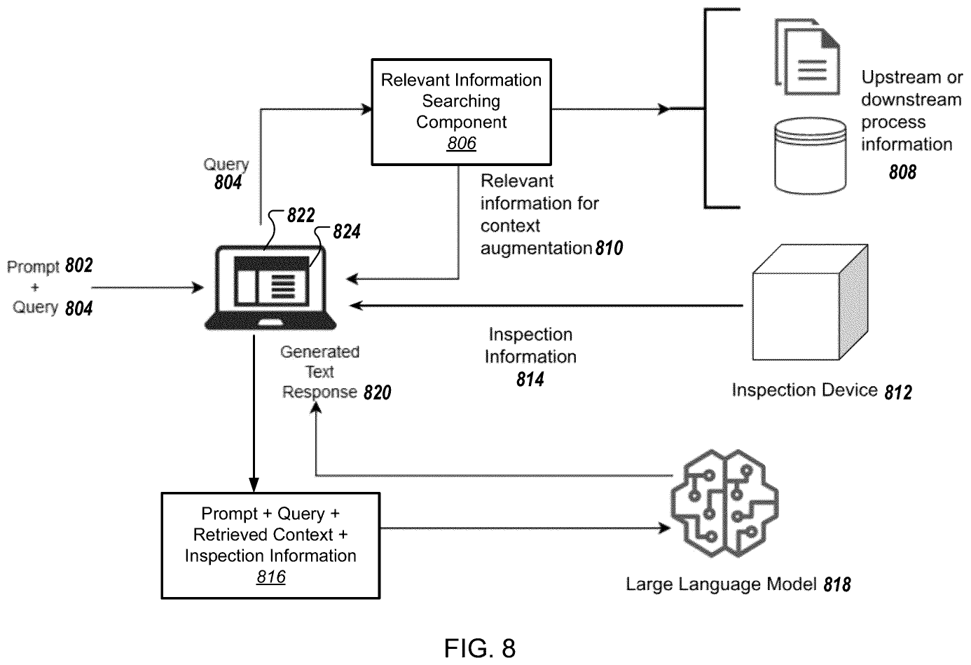

FIG. 8 is a diagram showing an example of using artificial intelligence (AI) in generating a response for a production task. The techniques and implementations described in connection with FIG. 8 can also be used in any of the systems 100, 200, 300, 500, 600, 630, and 700. Using an artificial intelligence (AI) model, a computer 822 can obtain a response for a prompt input related to a task in production. By providing perception data, e.g., inspection information such as X-ray or CT scan data and/or its reconstruction, to the AI model, the computer 822 can obtain more relevant and more useful responses from the AI model to aid in production tasks.

For example, it can be valuable to understand what caused a given defect in a manufactured object. An AI agent equipped with a knowledge database composed of the manufacturing steps used to make the object can provide valuable assistance in root cause determination for specific defects. The AI agent equipped with specific defect classifications provided by an inspection device can further provide valuable assistance in root cause determination for specific defects. The AI agent establishes relationships and correlations between various pieces of data in order to provide useful responses to aid in production tasks, such as determining a likely cause of a defect in an object. For example, the inspection device's classifications can correspond to the part numbers and subassemblies/assemblies referenced in the knowledge base. The knowledge base can include a mapping between the defect classifications and the assembly steps.

In some implementations, the computer 822 can be communicatively coupled with the X-ray system, e.g., through a network. For example, the computer 822 can be the computer 110 in FIG. 1. The computer 822 can include a hardware processor and a non-transitory computer-readable medium encoding instructions configured to cause the hardware processor to perform one or more operations described below.

The computer 822 can implement an agent of a production data analysis system. The production data analysis system can be a system for manufacturing, packaging, distributing, or other possible processes. The agent can be used either at the point of inspection, e.g., as a human machine interface (HMI) of an inspection system, or via an interface for remote monitoring and data analysis.

The agent can receive from a user interface 824 of the production data analysis system, a prompt input 802 based on a task for production related to an object. For example, the task can be root cause analysis of a problem, manufacturing process improvement, etc. Here, production related to an object can include manufacturing, assembly, joining, machining, marking, packaging, distributing, or other possible processes that involve the object. Besides the prompt input, the agent can receive from the user interface 824, a query 804. The agent can use the query to search for context information for production related to the object.

The agent receives context information for production related to the object, e.g., using the query 804. The context information can include relevant information 810 for context augmentation. For example, the agent can submit the query 804 to a relevant information searching component 806. The relevant information searching component 806 can search for context information for production related to the object in a knowledge database, such as a database that includes upstream and/or downstream process information 808.

The agent receives inspection data, e.g., inspection information 814, of the object, generated from an inspection device 812. For example, the agent can receive limited angle CT scan data 120 and/or its reconstruction from the limited angle X-ray system 100.

The agent provides the prompt input 802, the retrieved context information 810, and the inspection information 814 in a package 816 to an AI model, e.g., a large language model (LLM) 818. In some implementations, the agent further provides the query 804 in the package 816 to the AI model. The agent receives a response for the task from the AI model. For example, the agent receives generated text response 820 from the LLM 818.

The processes described above in connection with FIG. 8 use retrieval-augmented generation (RAG) by retrieving relevant context information 810 from knowledge sources that include upstream or downstream process information 808. In addition, inspection information 814 from an inspection device 812 and relevant context information 810 retrieved from knowledge sources are combined in the query 804 submitted to the LLM 818. By combining inspection information 814 from an inspection device 812 and knowledge of the manufacturing process (upstream and/or downstream process information 808), the agent of the production data analysis system can solve complex problems in production, such as root cause analysis and manufacturing process improvement. The inspection device 812 can be an optical inspection device, an X-ray inspection device, (e.g., a 2D X-ray device, a 3D X-ray CT device, or a limited angle X-ray device), or other possible inspection devices.

For example, if a specific screw is found to be missing on an item with a specific serial number, the system can determine that a technician at station C on shift 2 likely has missed the screw. In some implementations, a knowledge base of rework and remediation steps can be used instead of or in addition to a knowledge base of production steps in order to provide an instruction to correct defects detected in an assembly.

Referring back to FIG. 1, in some implementations, the system 100 can obtain and combine limited angle CT scan data from a series of limited angle CT scans. Compared with limited angle CT scan data obtained from a single scan, the limited angle CT scan data from multiple scans can include projections through an object at more angles, can provide more information of the object, and can be processed to generate a partial 3D reconstruction with improved quality.

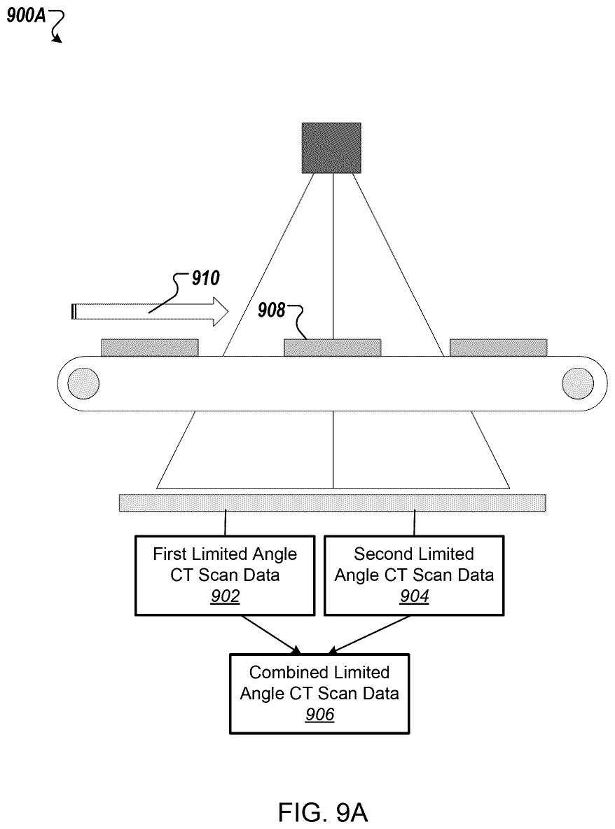

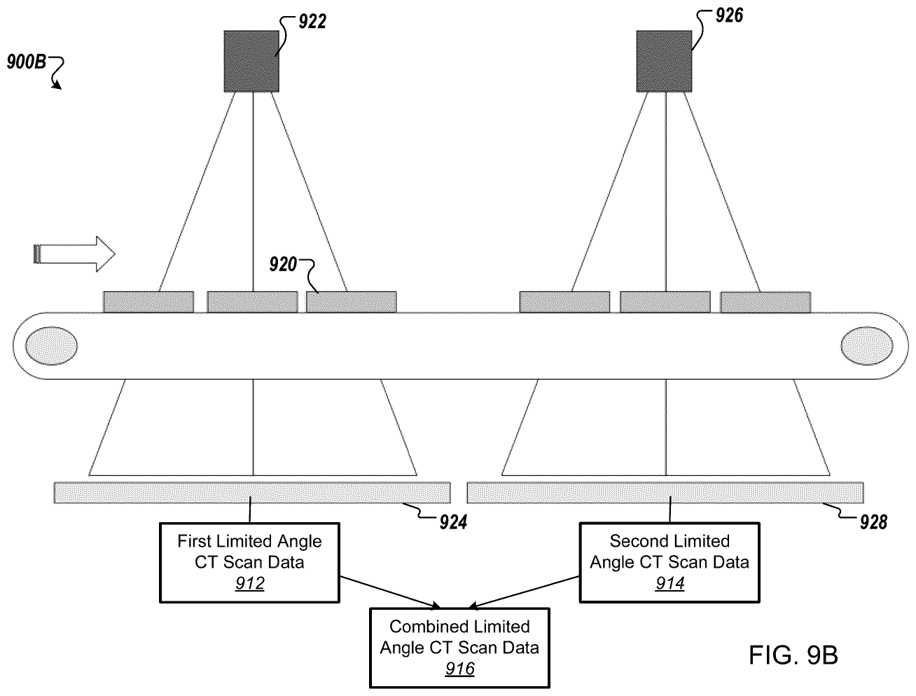

FIG. 9A shows a cross-sectional and schematic view of an example limited angle X-ray system 900A that obtains multiple limited angle CT scans. The previously described systems and techniques in FIGS. 1-8 can be used in the system 900B of FIG. 9A. An object 908 passes through the X-ray system 900A at least twice at different initial orientations of the object. Each time the object passes through the X-ray system 900A, the system 900A can obtain a corresponding limited angle CT scan of the object. The system 900A and/or a computer communicatively coupled with the system 900A can combine the at least two CT scans, e.g., first limited angle CT scan data 902 and second limited angle CT scan data 904, of the object to obtain combined limited angle CT scan data of the object, e.g., a combined limited angle CT scan data 906.

For example, the object 908 can pass through the X-ray system 900A multiple times following the same direction of travel 910, e.g., through a circular conveyor system. As another example, the object 908 can pass through the X-ray system 900A for the first time following a first direction of travel 910 and can pass through the X-ray system 900A for the second time following a second direction of travel that is the opposite of the direction of travel 910. The initial orientation of the object 908 can be varied between the multiple scans such that the system 900A can acquire additional projections of the X-rays of the object 908 at different orientations. For example, as discussed above, a component of the conveyor system (e.g., a guide rail system or a conveyed fixturing system) can rotate the object to a desired initial orientation and/or to varied orientations while the object passes through the X-ray system. The additional projections of the X-rays of the object can provide additional information about the object 908, improving the quality of the partial 3D reconstruction of the object 908.

In some implementations, the system 900A can include fiducials that can be used to determine the relationship between the orientations of the object among the multiple scans. For example, using the fiducials, the system 900A can determine that the initial orientations of the object among the two scans are offset by 15 degrees. Thus, the system 900A can determine that the first scan data includes projections at 0, 30, 60, and 90 degrees, and the second scan data includes projections at 15, 45, 75, and 105 degrees. Combining the projections from the two scans, the system 900A can obtain combined limited angle CT scan data including projections at 0, 15, 30, 45, 60, 75, 90, and 150 degrees, providing more information of the object.

FIG. 9B shows a cross-sectional and schematic view of an example limited angle X-ray system 900B that obtains multiple limited angle CT scans. The previously described systems and techniques in FIGS. 1-8 can be used in the system 900B of FIG. 9B. The system 900B includes a series of two or more CT scanners along a conveyor system. For example, the system 900B includes a first CT scanner including the X-ray source 922 and the detector 924, and a second CT scanner including the X-ray source 926 and the detector 928. An object 920 passes through the first CT scanner and the second CT scanner sequentially at different orientations. For example, the object can pass through the first CT scanner at a different initial orientation than passing through the second CT scanner. The system 900B obtains first limited angle CT scan data 912 of the object 920 while the object 920 passes through the first CT scanner with a first initial orientation. The system 900B obtains second limited angle CT scan data 914 of the object 920 while the object 920 passes through the second scanner with a second different initial orientation. The projections in the first scan are at different angles than the angles of the projections in the second scan, providing different information of the object. The system 900B and/or a computer communicatively coupled with the system 900B can generate combined limited angle CT scan data 916 of the object 920. The combined limited angle CT scan data 916 includes the first limited angle CT scan data 912 and the second limited angle CT scan data 914. In some implementations, the system 900B can include fiducials that can be used to determine the relationship between the orientations of the object among the multiple scans.

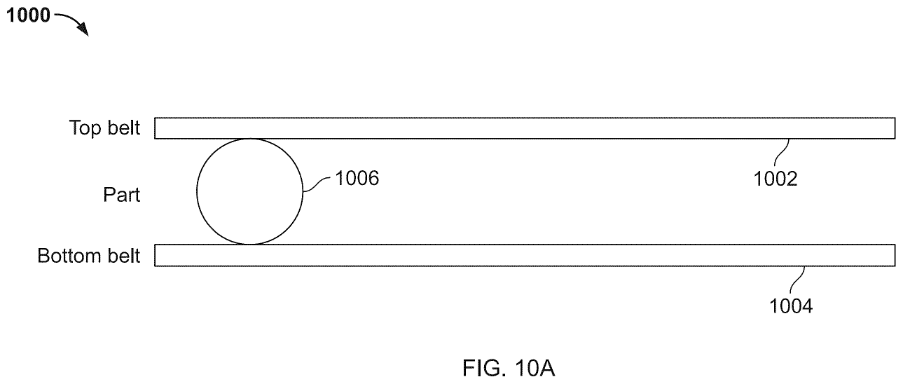

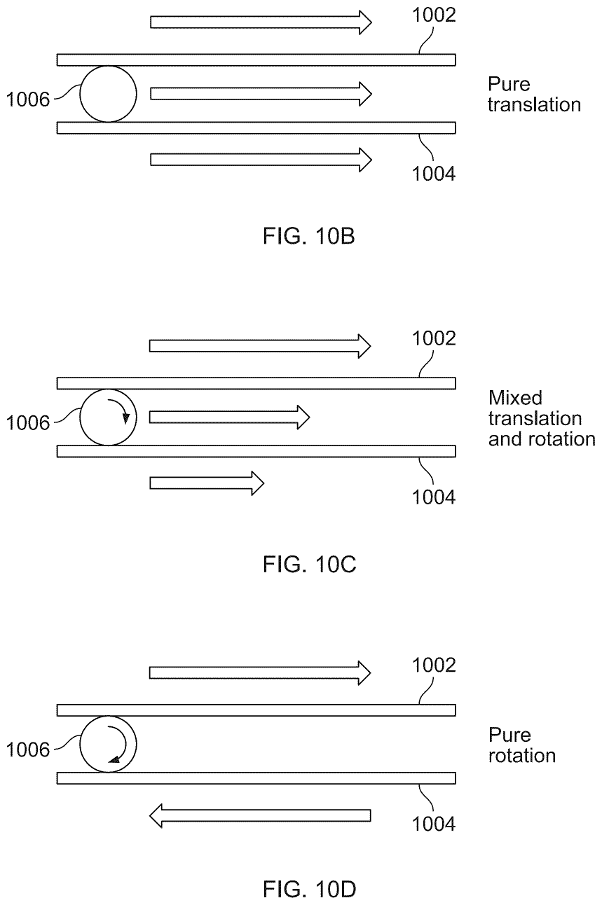

FIG. 10A shows an example conveyor system 1000 in a limited angle X-ray system. In some implementations, an example of the limited angle X-ray system is system 100 in FIG. 1. The example conveyor system 1000 can be an example of conveyor system 108 in FIG. 1. As shown in FIG. 10A, the example conveyor system 1000 can include two or more belts (also referred to as rollers or conveyors), e.g., a top belt 1002 and a bottom belt 1004. A part 1006 has a circular exterior surface (or a fixture that receives the part and has a circular exterior surface) and is positioned between the two belts and can move with a translational motion and/or a rotational motion, depending on the relative motion between the two belts. The relative motion between the two belts can result from a coordinated action from the two belts. In some cases, the two belts can be two counter-acting belts that cause part 1006 to move. In some cases, the two belts cause part 1006 to move through the friction between part 1006 and the two belts. Part 1006 can be an example of object 106 in FIG. 1. In some cases, when the motion of part 1006 includes a rotational motion, the axis of the rotation of part 1006 can be normal to the direction of translation of part 1006 (e.g., direction 105 in FIG. 1). In some cases, the direction of translation and/or rotation axis of part 1006 may be normal or oblique to the imaging axis defined by the X-ray source (e.g., 101 in FIG. 1) and the detector (e.g., 103 in FIG. 1) of the limited angle X-ray system. In some cases, part 1006 can be acted upon directly by the two belts, or set into fixturing that has a circular exterior surface and is acted upon by the two belts. In some implementations, the motion of part 1006 depends on the motion of each of the two belts, as shown in FIGS. 10B to 10D.

FIG. 10B shows an example motion of part 1006 moved by the example conveyor system 1000 in FIG. 10A. As shown in FIG. 10B, the top belt 1002 and the bottom belt 1004 have the same motion, for example, the two belts both move in the same direction and with the same velocity. Consequently, part 1006 has a pure translational motion with the same direction and velocity as those of belt 1002 and belt 1004.

FIG. 10C shows a second example motion of part 1006 moved by the example conveyor system 1000 in FIG. 10A. As shown in FIG. 10C, the top belt 1002 and the bottom belt 1004 move with different velocities, which can cause part 1006 to have a mixed translational motion and rotational motion. For example, belts 1002 and 1004 can move in the same direction but at different speeds, causing part 1006 to have both a translational motion and a rotational motion.

FIG. 10D shows a third example motion of part 1006 moved by the example conveyor system 1000 in FIG. 10A. As shown in FIG. 10D, the top belt 1002 and the bottom belt 1004 move in the opposite directions but at the same speed, causing part 1006 to have a pure rotational motion.

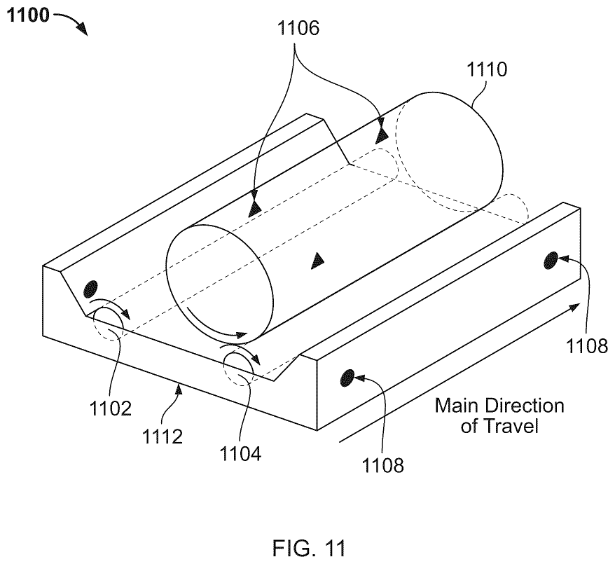

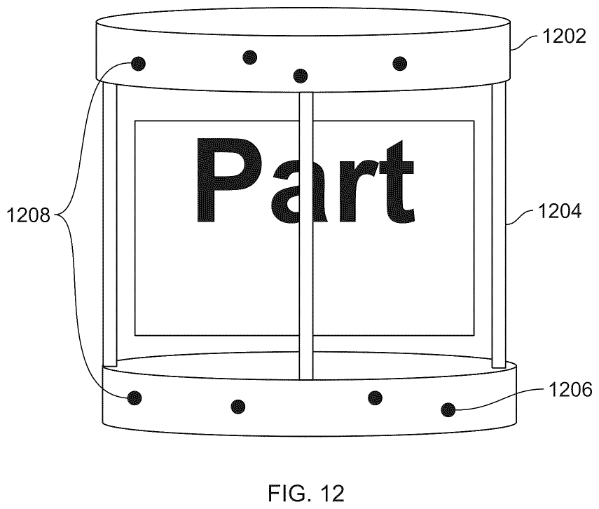

FIG. 11 shows another example conveyor system 1100 in a limited angle X-ray system. In some implementations, an example of the limited angle X-ray system is system 100 in FIG. 1. The example conveyor system 1100 can be an example of conveyor system 108 in FIG. 1. As shown in FIG. 11, the example conveyor system 1100 can include a fixturing tray 1112 with (active) rollers 1102 and 1104. Tray 1112 can hold a part 1110 between two rollers 1102 and 1004, which can be in contact with part 1110 to cause a rotational motion of part 1110 when part 1110 transits the limited angle X-ray system. Therefore, part 1110 can have a translational motion due to the motion of tray 1112, as well as a rotational motion due to the motion of rollers 1102 and 1104. In some implementations, the direction of translation of part 1110 can be coaxial with the axis of the rotation of part 1110. Part 1110 can include multiple part tracking fiducials 1106 to track the realized relative translational and/or rotational motions of part 1110 when it is moving through the limited angle X-ray system. Tray 1112 can include one or more tray tracking fiducials 1108 to track the motion of tray 1112.

In some implementations, the example conveyor system 1100 can be part of a fixture with localized shielding. For example, the example conveyor system 1100 can be part of the fixturing substrate 612 in FIG. 6A or 642 in FIG. 6B, while part 1110 is shielded from shielding 608 in FIG. 6A or shielding 638 in FIG. 6B.

In some implementations, the example conveyor system 1000 or 1100 can provide for different motion trajectories of part 1006 or 1110, and/or source-part-detector acquisition geometries. The components of the example conveyor system 1000 or 1100 can be inexpensive and can offer high lifetime. In some implementations, two actuators operating the belts are sufficient to achieve linear and rotational motion. Traditional motion systems would include a discrete rotational actuator and additional motion actuators for conveyance and exchange. The belt-drive actuators are reliable industrial components. The example conveyor system 1000 or 1100 can be combined with appropriate sensing or motion tracking to derive high precision inspection.

In some implementations, the example conveyor system 1000 or 1100 can allow interrogation of a set of positions and angles without extra motion of exchange (e.g. reciprocal pick and place or part exchange). In some implementations, the interrogation can be achieved by a series of linear and rotational manipulations. The interrogation is faster than exchange from a conveyance system to a separate inspection system, followed by manipulation in the inspection system. Consequently, throughput can be increased with more active signal-capture time. The example conveyor system 1000 or 1100 can be less expensive than a gantry for rotating the source and detector assembly, which can have demanding mechanical requirements on precision and demanding electrical requirements on passing power and data to and from the rotating frame.

In some implementations, for parts with compatible geometry, i.e., a circular exterior surface, the example conveyor system 1000 or 1100 can enable manipulation of the part without a secondary part fixture/holder. Consequently, the overall process design can be simplified and the cost of the overall inspection system (e.g., the limited angle X-ray system) can be reduced.

In some implementations, in addition to conventional rotation-in-place, scan data can be acquired from a combined translation and rotation of the part being imaged. When compared to helical CT, the example conveyor system 1000 or 1100 can leverage perpendicular rather than coaxial motion of the part being imaged. The configuration of the example conveyor system 1000 or 1100 can offer speed and cost advantages, without using a large detector area for part exchange. The configuration can also reduce the number of motion axes required for imaging the part. The configuration relies on reliable and low-cost components which can be important for industrial inspection equipment.

FIG. 12 shows example fiducials (or markers) used for motion tracking of a part imaged by a limited angle X-ray system. In some implementations, an example of the limited angle X-ray system is system 100 in FIG. 1, and an example of the part is object 106 in FIG. 1 use the fiducials described in connection with FIG. 12. The fiducials can be on the part or a part fixture holding the part. In some cases, each fiducial can be a distinct portion of a single fiducial marker. For example, the fiducials can be multiple known points on a known screw that will be present in each object being scanned. As shown in FIG. 12, fiducials (or markers) 1208 can be on a large diameter carbon fiber tube 1202 (top, bottom, or both) holding the part and connected by carbon fiber rods 1204. Some of the fiducials 1208 can be tungsten spheres 1206 adhered to the surface of carbon fiber tube 1202.

In some implementations, X-ray image data of a part, obtained by scanning the part using the limited angle X-ray system, can be used to determine the actual realized motion trajectory of the part from the motion of markers on the part or a part fixture holding the part. In some cases, a priori knowledge about the relative positions and orientations of at least two fiducials in a three-dimensional (3D) coordinate system of the part being scanned is obtained first, and consequently the position and orientation of the part in each X-ray image of the part can be determined. Therefore, the reconstructed 3D position and/or orientation data of the fiducials (or markers) determined from the X-ray images of the part can be transformed into a common reference frame to determine the realized motion trajectory (e.g., position and orientation) of the part.

In some implementations, the markers (or one or more fiducials on each marker) may be (1) a configuration of existing internal components of the part or the fixture that are suitable for tracking (e.g. internal fasteners, pins, high density inclusions, etc.). In some cases, suitability can be determined by contrast, lack of ambiguity through tracking, and/or rigid physical pattern whose location and orientation can be uniquely determined through space; (2) pattern of markers made of X-ray contrast material applied to the part, e.g. a metal foil tape, a pattern of metal foil tape, and/or a spray pattern of metallic or other high-Z material; (3) pattern of markers made of X-ray contrast material applied to the conveyor that is used to move the part, from which relative conveyance between X-ray image frames can be determined; and (4) a pattern of markers made of X-ray contrast material applied to a carrier or fixture that is rigidly fixed to the part.

In some implementations, motion tracking can give information about the actual realized trajectory of the part, which is valuable to reconstruction and analysis. Motion tracking can allow closed loop control of the motion system, as well as data quality improvements by improving on the assumption of ideal rigid body motion of the part. In some implementations, tracking the fiducials can yield position data that can be used to ensure that the part has reached the desired location with respect to the source and detector. The rate of speed of one or both belts can be modified to fine tune the positioning of the part. Differences in position can result from the mass properties of the parts to be inspected (wobbling, tilting, etc.), or from expected part-to-part variation, or variation between the actual and nominal part geometry.

In some implementations, the data acquisition of a limited angle X-ray system can encompass less than 180° of rotation of the X-ray source plus a cone angle (or fan angle) of the X-ray source. For example, if the X-ray source rotates 5 revolutions (i.e., 1800° in total), but the X-ray system only takes data acquisitions that encompass less than 180° of rotation of the X-ray source plus the cone angle of the X-ray source, the X-ray system is still a limited angle X-ray system. Therefore, the angular range that the data acquisition of the X-ray system covers determines whether the X-ray system is a limited angle X-ray system. In some implementations, within X-ray systems that capture data with limited angular range, a particular set of implementations can provide particular advantages in terms of high benefit to cost ratios, for example, benefit of good data vs low equipment cost, or benefit of good data vs low cost in terms of ionizing dose delivered.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented using one or more modules of computer program instructions encoded on a non-transitory computer-readable medium for execution by, or to control the operation of, data processing apparatus. The computer-readable medium can be a manufactured product, such as a hard drive in a computer system or an optical disc sold through retail channels, or an embedded system. The computer-readable medium can be acquired separately and later encoded with the one or more modules of computer program instructions, such as by delivery of the one or more modules of computer program instructions over a wired or wireless network. The computer-readable medium can be a machine-readable storage device, a machine-readable storage substrate, a memory device, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, a runtime environment, or a combination of one or more of them. In addition, the apparatus can employ various different computing model infrastructures, such as web services, distributed computing, and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media, and memory devices, including by way of example semiconductor memory devices, e.g., EPROM (Erasable Programmable Read-Only Memory), EEPROM (Electrically Erasable Programmable Read-Only Memory), and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., an LCD (liquid crystal display) display device, an OLED (organic light emitting diode) display device, or another monitor, for displaying information to the user, and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The computing system can include clients and servers. A client and server are generally remote from each other and typically interact through a communication network. The relationship of client and server arises by virtue of computer programs running on the respective computers and having a client-server relationship to each other. Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While this specification contains many implementation details, these should not be construed as limitations on the scope of what is being or may be claimed, but rather as descriptions of features specific to particular embodiments of the disclosed subject matter.

Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desired results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the invention have been described. Other embodiments are within the scope of the following claims.

What is claimed is:

1. An X-ray system, comprising:
a stationary X-ray source configured to emit X-rays; and
at least one detector configured to obtain limited angle computed tomography (CT) scan data of an object as the object passes through the X-ray system, wherein:
the limited angle CT scan data comprises projections of the X-rays after interaction with the object having been moved through an angular range with respect to at least one straight line between the stationary X-ray source and the at least one detector; and
a conveyor system moves the object in a product handling line, a component of the conveyor system rotates the object around an axis that is normal or oblique to a travel direction of the conveyor system, and the limited angle CT scan data comprises the projections of the X-rays after the interaction with the object having been rotated through the angular range around the axis.

2. The X-ray system of claim 1, wherein the at least one detector comprises two or more stationary linear detectors located along the conveyor system that moves the object in the product handling line, the limited angle CT scan data comprises two or more projections obtained at the two or more stationary linear detectors, wherein the angular range is between 5 and 125 degrees.

3. The X-ray system of claim 1, wherein the at least one detector comprises a linear detector located along the conveyor system that moves the object in the product handling line, the limited angle CT scan data comprises two or more projections obtained while the linear detector moves based on the travel direction of the conveyor system, wherein the angular range is between 5 and 125 degrees.

4. The X-ray system of claim 1, wherein the at least one detector is stationary.

5. The X-ray system of claim 1, wherein the component of the conveyor system is a guide rail system of a conveyor.

6. The X-ray system of claim 1, wherein the component of the conveyor system is a conveyed fixturing system that holds the object on a conveyor.

7. The X-ray system of claim 1, comprising fiducials for at least one of: material identification, motion tracking, physical alignment, and/or calibration.

8. The X-ray system of claim 7, wherein the fiducials are configured to be used to ascertain both a location and an orientation of the object, thereby ensuring the physical alignment.

9. The X-ray system of claim 7, wherein the fiducials comprise two or more fiducials on the object, and the two or more fiducials are configured and arranged to track a motion of the object when the object moves in the product handling line.

10. The X-ray system of claim 9, wherein the two or more fiducials are at least one of: (1) internal components of the object, (2) fiducials positioned on the object, (3) fiducials positioned on the conveyor system, or (4) fiducials positioned on a conveyed fixturing system that holds the object on a conveyor.

11. The X-ray system of claim 1, further comprising a filter placed between the stationary X-ray source and the object, wherein a portion of the X-rays that passes through the filter has a different energy spectrum than the X-rays emitted from the stationary X-ray source, and the limited angle CT scan data comprises the projections of at least two portions of the X-rays at different energy spectra after the interaction with the object.

12. The X-ray system of claim 1, wherein the object comprises an X-ray sensitive component, a shielding designed based on the X-ray sensitive component is placed between the object and the stationary X-ray source and reduces an amount of the X-rays that interact with the X-ray sensitive component of the object.

13. The X-ray system of claim 1, comprising:
an enclosure surrounding the stationary X-ray source and the at least one detector; and
an optical inspection device that is in the enclosure and is configured to generate optical inspection data of the object, wherein the optical inspection data and the limited angle CT scan data are combined to generate an inspection result of the object.

14. The X-ray system of claim 1, wherein the component of the conveyor system comprises two or more counter-acting rollers configured and arranged to rotate the object or move the object in the product handling line.

15. The X-ray system of claim 1, wherein the component of the conveyor system comprises two conveyor belts, and a distance between the two conveyor belts is sized to receive either (i) the object having a circular exterior surface or (ii) a fixture that receives the object therein and has a circular exterior surface.

16. The X-ray system of claim 1, wherein the object passes through the X-ray system at least twice, the limited angle CT scan data comprises the projections from each of at least two CT scans of the object corresponding to each passing of the object through the X-ray system at a different initial orientation of the object.

17. The X-ray system of claim 1, further comprising:
a second stationary X-ray source configured to emit second X-rays; and
at least another detector configured to obtain second limited angle CT scan data of the object as the object passes through the X-ray system and after the at least one detector obtains the limited angle CT scan data, wherein the second limited angle CT scan data comprises second projections of the second X-rays after second interaction with the object having been moved through a second angular range with respect to at least another straight line between the second stationary X-ray source and the at least another detector, wherein the second limited angle CT scan data comprises the second projections of the second X-rays after the second interaction with the object at a different initial orientation than an initial orientation of the object for the limited angle CT scan data; and
wherein a computer is communicatively coupled with the X-ray system and comprises a hardware processor and a non-transitory computer-readable medium encoding instructions configured to cause the hardware processor to generate CT scan data comprising the limited angle CT scan data and the second limited angle CT scan data.

18. A computer system communicatively coupled with an X-ray system, wherein the computer system comprises one or more hardware processors and a non-transitory computer-readable medium encoding instructions configured to cause the one or more hardware processors to:
receive, by an agent of a production data analysis system and from a user interface of the production data analysis system, a prompt input based on a task for production related to an object;
receive, by the agent, context information for the production related to the object;
receive, by the agent, inspection data of the object generated from limited angle CT scan data, wherein the limited angle CT scan data is obtained by the X-ray system as the object passes through the X-ray system;
provide, by the agent, the prompt input, the context information, and the inspection data to a large language model (LLM); and
receive, by the agent and from the LLM, a response for the task for the production related to the object.
